(19) United States
(12) Patent Application Publication
(10) Pub. No.: US 2015/0206204 A1
(43) Pub. Date: Jul. 23, 2015

(54) DETECTION AND INTERACTIVE SYSTEM

(71) Applicant: Shun-Fu Technology Corp., Taipei City (TW)

(72) Inventor: Yung-Sheng HUANG, Taipei City (TW)

(21) Appl. No.: 14/594,144

(22) Filed: Jan. 11, 2015

(30) Foreign Application Priority Data
Jan. 22, 2014 (TW) 103102218

(51) Int. Cl. G06Q 30/02; G06Q 10/10; H04W 4/12; G06Q 20/20

(52) U.S. Cl. CPC G06Q 30/0281; G06Q 20/202; G06Q 10/107; H04W 4/12

(57) ABSTRACT

A detection and interactive system of the invention includes an inspection end where a recognition code is input; at least one reader recognizing the inspection end when the inspection end enters a readable range of the reader, wherein the reader transmits a signal to drive the inspection end when the inspection end enters the readable range, the recognition code set in the inspection end is transmitted back to the reader, and the recognition code is transmitted to a processor from the reader and compared with a database by the processor; when the inspection end is identified by the reader, data of customers are transmitted to at least one electronic service system via a media device.

### BACKGROUND OF THE INVENTION

1. Field of the Invention

The invention relates to a detection and interactive system recognizing a customer and providing related information for service staffs and an electronic service system to provide active service.

2. Description of the Related Art

It is often seen that when customers enter the shop and look for something they want to buy, if they have questions, they may ask staffs and get some answers, and finally they pay their bill and leave the shop. In some shops, when customers enter the shop, staffs actively ask the customers what they want and provide some information for the customers. However, staffs have no information about the customers, and thus cannot provide better service and sometime may make the customers feeling uncomfortable.

A conventional member service system only has personal profiles and may be provides member card or VIP card for identification and even for discount, shopping record, deliver advertisement or discount information. However the conventional member service system cannot analyze members consuming habit and thus cannot provide active service.

In addition, in a public environment, customers come and go, it is difficult for staffs to recognize the VIP customers and cannot provide active service.

### BRIEF SUMMARY OF THE INVENTION

The object of the invention is to provide a detection and interactive system recognizing a customer and providing related information for service staffs and an electronic service system to provide active service.

Another object of the invention to provide a detection and interactive system recording and analyzing consuming habit of each member to provide active service.

The invention provides a detection and interactive system. The detection and interactive system in accordance with an exemplary embodiment of the invention includes an inspection end where a recognition code is input; at least one reader recognizing the inspection end when the inspection end enters a readable range of the reader, wherein the reader transmits a signal to drive the inspection end when the inspection end enters the readable range, the recognition code set in the inspection end is transmitted back to the reader, and the recognition code is transmitted to a processor from the reader and compared with a database by the processor; when the inspection end is identified by the reader, data of customers are transmitted to at least one electronic service system via a media device.

In another exemplary embodiment, the electronic service system is an information device.

In yet another exemplary embodiment, the electronic service system is a display device, a custom-made electronic device, a voice broadcast device, a smart watch, an electronic book, a laptop, a tablet or a watch.

In another exemplary embodiment, the electronic service system is linked to electronic mails, messages or applications.

In yet another exemplary embodiment, the media device transmits information to at least one informing device.

In another exemplary embodiment, the electronic service system displays the data of customers on the information device.

In yet another exemplary embodiment, the informing device comprises at least one mobile device.

In another exemplary embodiment, the informing device comprises at least one fixed device.

In yet another exemplary embodiment, the reader and the electronic service system are disposed on a counter.

In another exemplary embodiment, the reader and the electronic service system are disposed on a product display rack.

In yet another exemplary embodiment, the reader and the electronic service system are disposed on a product display rack.

In another exemplary embodiment, the reader and the electronic service system are disposed on an exhibition cabinet.

In yet another exemplary embodiment, the mobile device comprises a user identification electronic device.

In another exemplary embodiment, the fixed device comprises a user identification electronic device.

In yet another exemplary embodiment, the reader is disposed at a gate.

In another exemplary embodiment, the detection and interactive system is connected to a management system for points of sales.

In yet another exemplary embodiment, the detection and interactive system is connected to an electronic purse.

In another exemplary embodiment, the data base is connected to a network system.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flow chart of an embodiment of a detection and interactive system of the invention; and

FIG. 2 is a flow chart of an operation method of an identification electronic device of a mobile device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A detection and interactive system of the invention includes a reader capable of detecting an inspection end. The distance (ranging from tens of centimeter to over ten meter) between the reader and the inspection end is determined by the systems used in the reader and the inspection end. In some embodiments, the inspection end can used sensors for long distance or short distance. The long distance sensor is used for costumer detection system, and the short distance sensor is used for electronic payment system such as an electronic purse.

When the inspection end enters a readable distance of the reader, the reader transmits radio frequency wave to or communicates with the inspection end so that the inspection end transmits information to the reader actively or passively. A recognition code preset in the inspection end is transmitted to the reader, and the recognition code I compared with a data base by a processor.

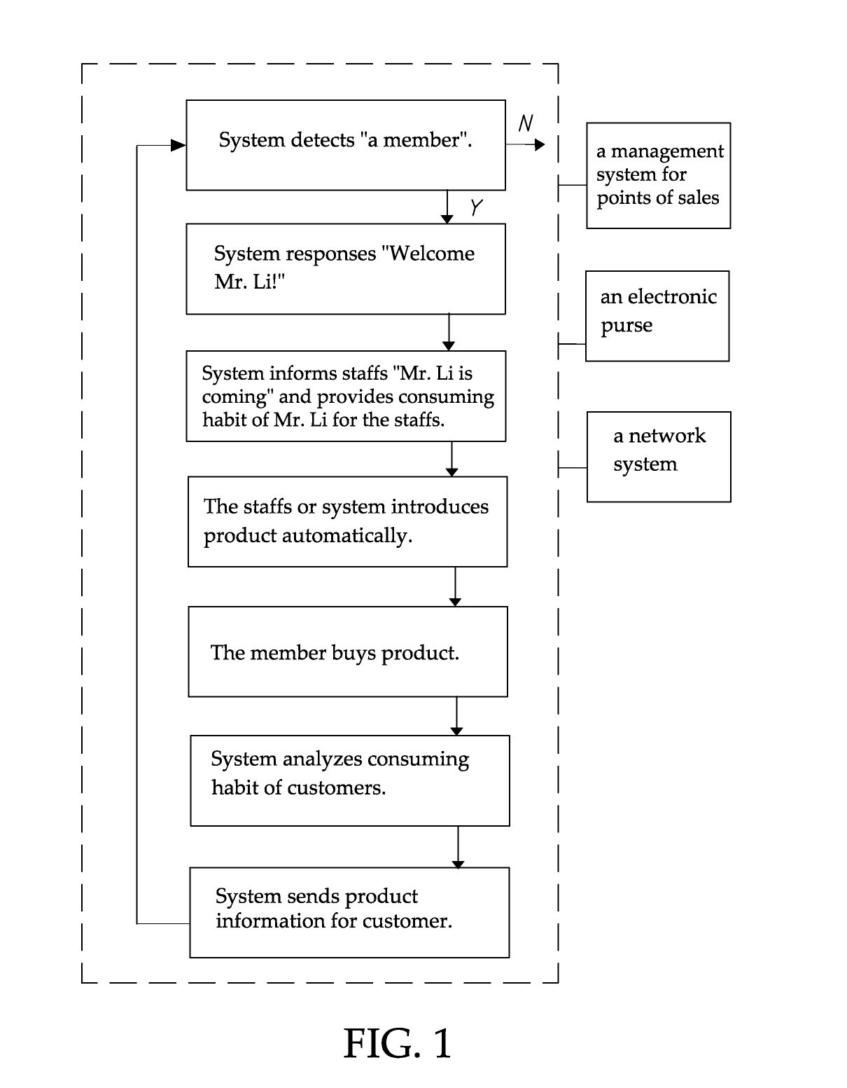

Referring to FIG. 1, the detection and interactive system of the invention compares the recognition code with the data base to determine whether the customer is a member. If the customer is verified to be a member, then an interactive procedure is performed as follows.

In a shopping mall, the interactive procedure includes: the detection and interactive system input information of a customer or member to an electronic service system, and greetings like “Welcome Mr. Li!” or “What can I do for you, Mr. Li?” or discount information for shopping is shown in a touch screen display device or other display device. An audio device starts to broadcast the greetings “Welcome Mr. Li!” or “What can I do for you, Mr. Li?” at the same time, whereby the detection and interactive system interacts with customers.

The display device can further show other information, for example:

1. Analyzing consuming habit, product trend and period.

2. Analyzing costumer's preference.

3. Estimate the time customers buy the product again when the product runs out.

4. Introducing new products.

5. Informing customers by sending text or vocal messages.

Customers of the inspection end can obtain the information mentioned above in a counter, a product display rack or an exhibition cabinet. The information of the products mentioned above can also be shown in an electronic service system connected to various display devices, a custom-made electronic device, a voice broadcast device, a smart watch, an electronic book, a laptop, a tablet, a watch, a message transmitting device or applications to facilitate product sale.

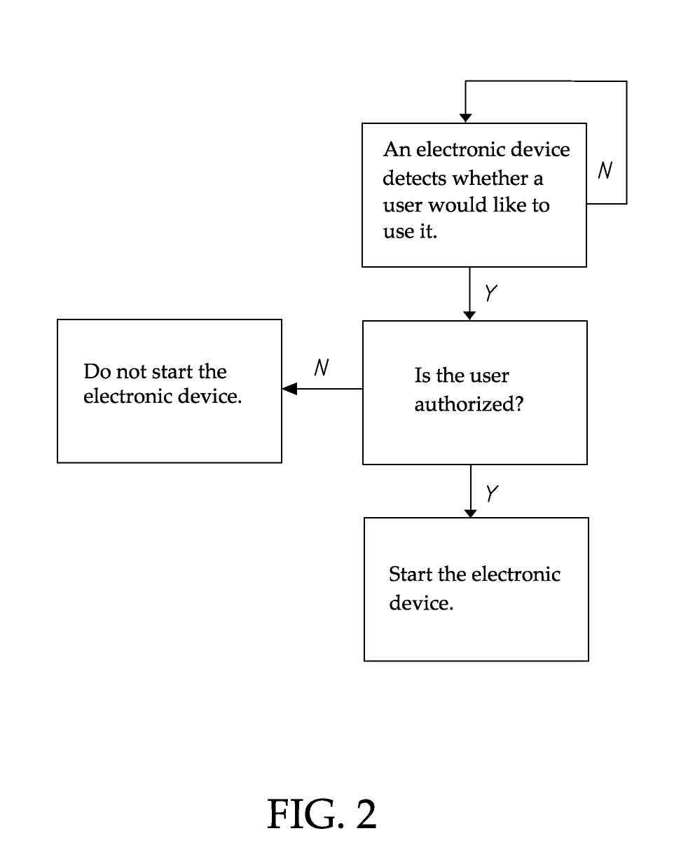

For international boutiques, as shown in FIG. 2, by means of the detection and interactive system, staffs can determine whether a customer is an ordinary costumer or a customer who has consumed something in this shop when he/she enters the gate, a personal profile of the customer, the member grade, preference or consuming habit through a mobile device such as a handheld device or a wearable device or a fixed device. The staff can provide active service such as active greeting, introducing products. To prevent unauthorized or embezzled activity, the mobile device or the fixed device further includes a staff identification electronic device. Each staff wears an identification tag corresponding to the staff identification electronic device. For example, the identification tag can be a identification card or a hand ring.

The detection and interactive system of the invention can analyze and count the customers consuming habit and condition to send advertisement or message about discount information, new product introduction or product consuming period actively.

The detection and interactive system of the invention can be connected to a management system for points of sales to perform better management.

The detection and interactive system can be connected to an electronic purse for electronic payment.

The data base of the detection and interactive system can be connected to a network system for global management.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A detection and interactive system, comprising:
an inspection end where a recognition code is input;
at least one reader recognizing the inspection end when the inspection end enters a readable range of the reader, wherein the reader transmits a signal to drive the inspection end when the inspection end enters the readable range, the recognition code set in the inspection end is transmitted back to the reader, and the recognition code is transmitted to a processor from the reader and compared with a database by the processor; when the inspection end is identified by the reader, data of customers are transmitted to at least one electronic service system via a media device.

2. The detection and interactive system as claimed in claim 1, wherein the electronic service system is an information device.

3. The detection and interactive system as claimed in claim 2, wherein the electronic service system is a display device, a custom-made electronic device, a voice broadcast device, a smart watch, an electronic book, a laptop, a tablet or a watch.

4. The detection and interactive system as claimed in claim 1, wherein the electronic service system is linked to electronic mails, messages or applications.

5. The detection and interactive system as claimed in claim 1, wherein the media device transmits information to at least one informing device.

6. The detection and interactive system as claimed in claim 2, wherein the electronic service system displays the data of customers on the information device.

7. The detection and interactive system as claimed in claim 5, wherein the informing device comprises at least one mobile device.

8. The detection and interactive system as claimed in claim 5, wherein the informing device comprises at least one fixed device.

9. The detection and interactive system as claimed in claim 1, wherein the reader and the electronic service system are disposed on a counter.

10. The detection and interactive system as claimed in claim 1, wherein the reader and the electronic service system are disposed on a product display rack.

11. The detection and interactive system as claimed in claim 1, wherein the reader and the electronic service system are disposed on an exhibition cabinet.

12. The detection and interactive system as claimed in claim 7, wherein the mobile device comprises a staff identification electronic device.

13. The detection and interactive system as claimed in claim 8, wherein the fixed device comprises a staff identification electronic device.

14. The detection and interactive system as claimed in claim 1, wherein the reader is disposed at a gate.

15. The detection and interactive system as claimed in claim 1, wherein the detection and interactive system is connected to a management system for points of sales.

16. The detection and interactive system as claimed in claim 1, wherein the detection and interactive system is connected to an electronic purse.

17. The detection and interactive system as claimed in claim 1, wherein the data base is connected to a network system.
